(19) United States
(12) Patent Application Publication
(10) Pub. No.: US 2018/0259033 A1
(43) Pub. Date: Sep. 13, 2018

(54) TUBULAR DRIVER FOR SHUTTERS

(71) Applicant: NICE S.P.A., Oderzo (IT)

(72) Inventor: Federico BASUTTO, Oderzo (IT)

(21) Appl. No.: 15/761,098

(22) PCT Filed: Sep. 23, 2015
(86) PCT No.: PCT/IB2015/057319

§ 371 Date: Mar. 18, 2018

(51) Int. Cl. F16F 15/08; E06B 9/58; E06B 9/72; E06B 9/322; E06B 9/17

(52) U.S. Cl. CPC F16F 15/08; E06B 9/582; E06B 2009/725; E06B 9/322; E06B 9/17; E06B 9/72

(57) ABSTRACT

To reduce the noise level and the conduction of vibrations in a driver (MC) for a roller shutter comprising an outer hollow tube (20) containing a gearmotor unit (10) adapted to actuate the roller shutter, two elastic elements (60, 90) are provided that are mounted inside the tube spaced apart and each adapted to suspend the gearmotor unit inside the tube, so that between the tube and the gear-motor unit an interspace (W) is created.

The invention generally relates to a tubular driver for roller shutters, like blinds, curtains or sectional shutters.

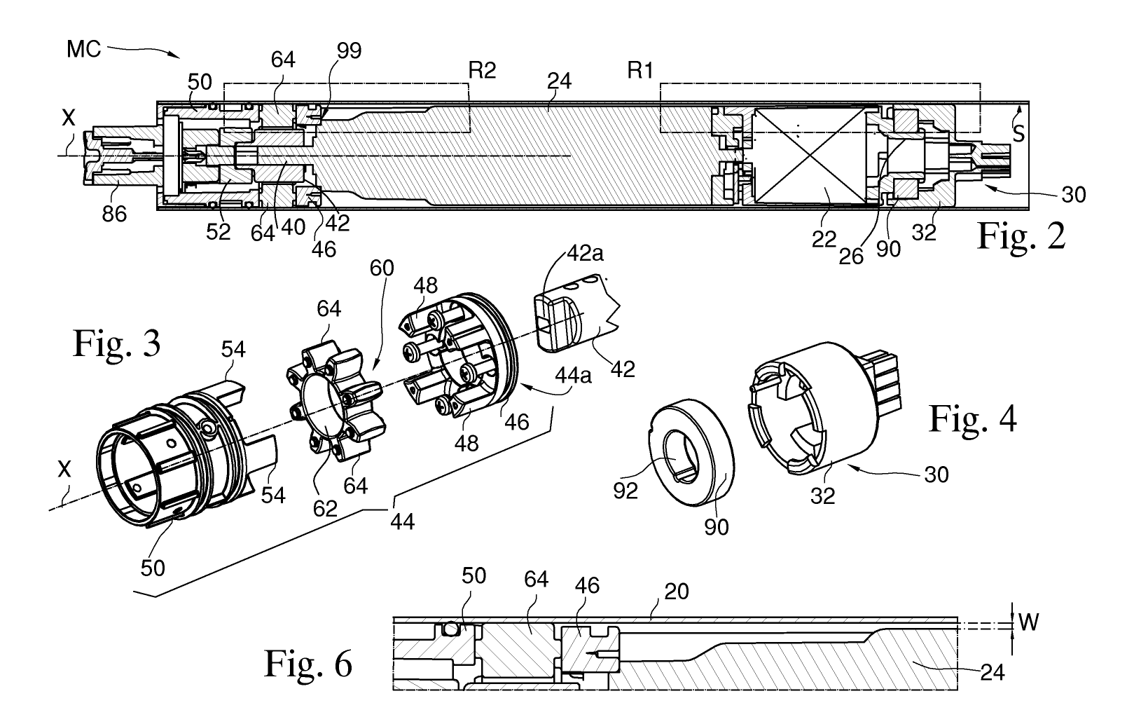

In tubular rpm-reducing gearmotors for roller shutters one problem is the noise, especially that due to vibrations. EP 1727959 proposes as solutions various actuating structures. E.g. (see FIG. 2) for fixing an electric motor to the outer containment tube, an absorbent pad 48 is arranged between the two. The motor is coupled to a gearmotor, which has in series an elastic means and an adapter to connect it to the shutter. Since the direct contact between the gearmotor and the outer tube facilitates the propagation of noisy vibrations, in better solutions (ibidem, FIGS. 4, 5 and 6) the motor is suspended inside the tube. In the variant of FIG. 4 the motor is mounted cantilevered inside the tube, with the unpleasant consequence that it can swing generating noise and an inherent structural weakness is created. In the variant of FIGS. 5 and 6, the motor is mounted inside a second tube which is kept suspended inside the first tube by an elastic, flexible means. In addition to a structure being altogether heavier and more expensive, it is necessary to use an adapter to compensate a misalignment between the motor, its shaft and the load.

Then it is desired to improve this state of the art, in particular producing a driver which is less noisy and simpler to construct. The driver comprises:

an outer hollow tube containing a gearmotor unit adapted to actuate the roller shutter,

characterized by comprising two elastic elements that are mounted inside the tube spaced apart and each adapted to suspend the gearmotor unit inside the tube, so that between the tube and the gearmotor unit an interspace is created.

This provision gives a lot of advantages: the gearmotor can be suspended while limiting the surface contact area with the tube, and therefore vibrations are limited. By placing elastic elements at the support points, necessarily vibrations going outwards must pass through them getting attenuated.

The gearmotor unit defined herein comprises an electric motor and a rpm-reducing gear unit, usually of epicyclic type, and optionally a brake for the motor. The rpm-reducing gear unit is the origin of most of the vibrations and noise.

Among the many possible advantageous variants for the driver, we mention:
an or each elastic element is placed directly between the gearmotor unit and the inner surface of the tube, e.g. thanks to the fact that one or each elastic element has radial dimension greater than the gearmotor unit.

This has the advantages of requiring few parts, of being simple to construct and the attenuating thickness can be increased with several degrees of design freedom; and/or
an or each elastic element has a shape complementary to the cross-section of the tube, e.g. ring-shaped. The advantage is that the elastic element is easy to assemble and produce, and attenuates on 360 degrees; and/or
an or each elastic element is made of soft or rubber material, e.g. more or less rigid plastic, to better dampen vibrations; and/or
an or each elastic element has a central opening in which the gearmotor unit is inserted to be supported, e.g. at one end or around its body. Thus the size of the interspace is increased, the gearmotor unit is easily coupled to the rest of the driver and mechanical stability is given to the gearmotor unit; and/or
an or each elastic element is mounted on an/each end of the gearmotor unit. Thus the gearmotor unit is supported at the points which are more distant from the noise source, attenuation is increased and stability maximized; and/or
an or each elastic element is contained in a piece which is mounted in direct contact with the inner surface of the tube. The goal is to increase the mechanical stability of the gearmotor unit, or to increase the attenuation by producing the piece out of material which is absorbent and/or compatible with that of the elastic element; and/or
an or each elastic element has the form of a toothed wheel or toothed ring whose teeth are arranged circularly and in the radial direction. This minimizes the surface contact area with the tube, and allows the effective interlocking with a (e.g. rigid) piece to support the motor; and/or
as simple but very stable coupling, the piece comprises axially projecting teeth adapted to be disposed between those of the elastic element by means of shape fitting, the teeth of the elastic element having radial length greater than the maximum length of the piece; and/or
the gearmotor unit comprises a brake for braking an output shaft of its, so as to attenuate the noise of the brake; and/or
the interspace is filled with sound-absorbing material, to increase attenuation.

The following description relates to a preferred embodiment of driver and will highlight its further advantages, with reference to the accompanying drawings wherein:

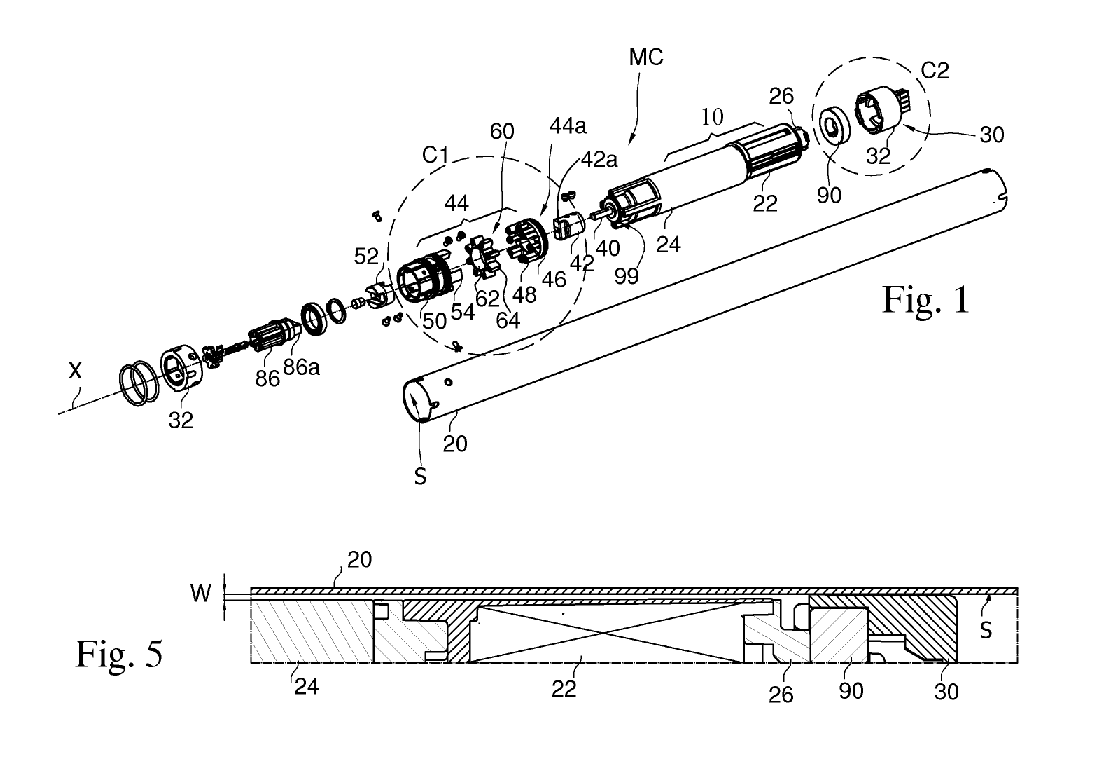

FIG. 1 shows an exploded view of the driver;

FIG. 2 shows a longitudinal section of the driver,

FIG. 3 shows an enlarged view of the elements inside the circle C1 of FIG. 1;

FIG. 4 shows an enlarged view of the elements inside the circle C2 of FIG. 1;

FIG. 5 shows an enlarged view of the elements inside the rectangle R1 of FIG. 2.

FIG. 6 shows an enlarged view of the elements inside the rectangle R2 of FIG. 2.

A tubular driver MC is formed by a cylindrical, outer tube 20 which houses within it an electric gearmotor 24, i.e. the assembly of an electric motor plus an rpm-reducing planetary gear, coupled to an (optional) brake 22 of known type. The gearmotor 24 and the brake 22 both have a cylindrical shape with axis X, and the gearmotor 24 has an output pin 40 rotatable about the axis X. The brake 22 and the gearmotor 24 form a unit of the driver MC here defined gearmotor unit 10.

The rotary motion of the pin 40 is transferred to an output shaft 86 via an Oldham coupling able to compensate for any misalignment between the pin 40 and the shaft 86. The coupling is formed by a bushing 42 having a beak 42a inserted into a first slot of a second bushing 52, which has a second slot, in a position opposite to the first, in which there is inserted a beak 86a of the shaft 86. The two slots of the bushing 52 are oriented at 90 degrees from one another.

One end of the gearmotor unit 10 narrows in diameter, e.g. at the end relative to the brake 22, and exhibits a pin 26, around which a ring 90 made of elastic material, e.g. rubber, can be inserted coaxially. The ring 90 is in practice a torus, with diameter of the central opening 92 (FIG. 4) nearly equal to that of the pin 26. A plug 30 is placed for closure of the tube 20 (e.g. by means of screws, not illustrated) and substantially comprises a hollow cylindrical shell 32 whose internal cavity is adapted to house and lock coaxially the ring 90

The other end of the gearmotor unit 10 abuts on and is supported by a support and connection group 44. As best seen from FIG. 3, the group 44 comprises an element 44a, a suspension element 60 and a body 50.

The element 44a in turn comprises a disc 46 having a central pass-through cavity. The end of the gearmotor 24 relative to the pin 40 is inserted into the element 44a. Either such end rests on a circular shoulder towards the inside present in the cavity of the element 44a or the end of the gearmotor has a circular shoulder (see reference 99) for leaning snugly on the edges of said cavity. From the periphery of the disc 46 there extend orthogonally teeth or pins 48 (therefore parallel to the axis X) facing the opposite direction of the gearmotor 24.

The element 44a is coupled axially with the suspension element 60, which is formed by a central ring 62, having an axial pass-through opening, and by teeth 64 that extend radially with respect to and from the ring 62. The teeth or pins 48 of the element 44a are shaped to be inserted into the void radial space present between the teeth 64, but are numerically inferior and therefore they do not occupy them all.

The body 50 is essentially a hollow cylindrical shell, of a diameter equal to or less than that of the tube 20, and comprises, at the end facing the gearmotor 24, teeth 54 arranged with circular symmetry parallel to the axis X and in opposite direction to the teeth 48, which can be axially insert into free radial spaces between the teeth 64.

When assembly of the group 44 is made, it ends up that circumferentially to the element 60, namely between its teeth 64, an alternating series of teeth 48, 54 is arranged. The diameter of the gearmotor unit 10 is less than the internal diameter of the tube 20 and the maximum diameter of the element 60 (considered as the distance between two ends of two opposite teeth 64 or the inscribed circle passing through the tips of the teeth 54). Such maximum diameter is greater than both (i) the maximum diameter of element 44a and its disk 46, and (ii) the maximum diameter of the body 50. Thus the teeth 64 protrude radially from the assembled group 44, they are the only that make contact with the surface S and they keep one end of the gearmotor unit 10 suspended and spaced from the surface S. Therefore, the group 44 forms a non-rotational assembly, which is integral with the tube 20 and thanks to which any oscillating movement imposed to the element 44a by the inertia of the gearmotor 24 is absorbed/compensated by the suspension element 60. The body 50 and/or the element 44a may be fixed by means of screws, not shown, to the inner surface S of the tube 20.

Thus, ultimately, the gearmotor unit 10 is suspended and locked axially inside the tube 20 on one side by the plug 30, and on the other by the supporting assembly 44. In particular the gearmotor unit 10 remains suspended within the tube 20 supported at two ends: on one side by the ring 90 and the plug 30, and on the other side by the group 44.

Consequently between the gearmotor unit 10 and the surface S a hollow circular interspace W is formed, which is insulating and sound-absorbent, and e.g. has 0.8-1.2 mm thickness. Thanks to the interspace W the noise of the driver is drastically reduced, as well as the vibrations transmitted to and by the tube 20. The group 44 does not prevent the transmission of motion to the outside, because the pin 40 and the above bushing 42 cross centrally and axially (along the X axis) the group 44 to connect to the bushing 52, arranged within the body 50, thereby being able to operate the output shaft 86.

### VARIANTS

The invention is open to many variants, all of which can be implemented alone or in combination, e.g.:
the element 60 can have teeth 64 in a variable number and/or arranged with radial symmetry or not; idem for the teeth 48 of the element 44 or the teeth 52 of element 50; and/or
the element 60 or the group 44 can be a suspension ring, e.g. like the 90, fitted around the end of the motor 22 to touch directly the surface S; and/or
the ring 90 may be mounted outside of the plug 30, so as to support the pin 26 while directly touching the surface S; and/or
the presence in the unit 10 of the brake 22, though optional, is advantageous. In fact, since also the brake 22 is suspended within the tube 20, thanks to two elastic elements, also the vibrations that are generated during braking are attenuated towards the tube 20; and/or
the plug 30 can be realized not only as a single piece, advantageously having an electrical connector at one end for supplying electronic control boards housed in it, but also as two or more pieces (the seat for the ring 90 remains unchanged); and/or
the material forming the ring 90 and/or the element 60 may be plastic, rubber, EVA, cork, polyurethane, foam-rubber, or in general a soft material (i.e. that can compress elastically under pressure), flexible and/or porous and/or foamed. The same material can be inserted in the interspace; and/or
the tube 20 may also have a polygonal or elliptical cross-section. What has been said before referred to a diameter should then be understood as maximum radial length or diameter of the circumscribed circumference.

The shape e.g. of the ring 90 or the group 44 or the element 60 will be amended accordingly.

1. Driver (MC) for a roller shutter comprising:
an outer hollow tube (20) containing a gearmotor unit (10) adapted to actuate the roller shutter,
characterized by comprising
two elastic elements (60, 90) that are mounted inside the tube spaced apart and each adapted to suspend the gearmotor unit inside the tube, so that between the tube and the gear-motor unit an interspace (W) is created.

2. Driver according to claim 1, wherein an or each elastic element (60) is placed directly between the gearmotor unit and the inner surface (S) of the tube.

3. Driver according to claim 1, wherein an or each elastic element has a shape complementary to the cross-section of the tube, e.g. ring-shaped.

4. Driver according to claim 1, wherein an or each elastic element is made of soft or rubber or plastic material.

5. Driver according to claim 1, wherein an or each elastic element (60, 90) has a central opening (62, 92) in which the gear motor unit is inserted to be supported.

6. Driver according to claim 1, wherein an or each elastic element is mounted on an/each end of the gearmotor unit.

7. Driver according to claim 1, wherein an or each elastic element is contained in a piece (30, 50) which is mounted in direct contact with the inner surface of the tube.

8. Driver according to claim 1, wherein an or each elastic element (60) has the form of a toothed wheel or toothed ring whose teeth (64) are arranged circularly and in the radial direction.

9. Driver according to claim 7, wherein the piece (50) comprises axially projecting teeth (54) adapted to be disposed between those of the elastic element by means of shape fitting, the teeth (64) of the elastic element having radial length greater than the maximum one of the piece.

10. (canceled)
